(19) United States
(12) Patent Application Publication
(10) Pub. No.: US 2025/0310227 A1
(43) Pub. Date: Oct. 2, 2025

(54) REMOTE MONITORING APPARATUS

(71) Applicant: SEIKO EPSON CORPORATION, Tokyo (JP)

(72) Inventor: Takayuki SHIMIZU, Shiojiri-shi (JP)

(21) Appl. No.: 19/087,825

(22) Filed: Mar. 24, 2025

(30) Foreign Application Priority Data
Mar. 28, 2024 (JP) 2024-053969

(51) Int. Cl. H04L 43/0817; G06Q 50/18

(52) U.S. Cl. CPC H04L 43/0817; G06Q 50/182

(57) ABSTRACT

A remote monitoring server acquires a first monitored number as a number of projectors for which a first organization as a subject of a remote monitoring service has a management authority, a second monitored number as a number of projectors for which the first organization has a management authority or a reference authority, and a common monitored number as a number of projectors for which both the first organization and another organization have a management authority, a reference authority, or a second monitoring authority. Further, the remote monitoring server calculates a monitored number of the first organization by subtracting the common monitored number from the sum of the first monitored number and the second monitored number.

The present application is based on, and claims priority from JP Application Serial Number 2024-053969, filed Mar. 28, 2024, the disclosure of which is hereby incorporated by reference herein in its entirety.

### BACKGROUND

### 1. Technical Field

The present disclosure relates to a remote monitoring apparatus.

### 2. Related Art

A management apparatus that provides a monitoring service for monitoring operation states of a plurality of projectors connected via a network is known. For example, a management apparatus disclosed in JP-A-2012-15832 groups a plurality of projectors based on position information. The management apparatus displays the installation positions of the projectors on a map in units of groups.

JP-A-2012-15832 is an example of the related art.

A contract with a monitoring service provided by a management apparatus in related art is generally made in units of organizations such as companies. In this contract, the upper limit number of projectors to be monitored is often specified.

However, an organization that is a subject of a contract and receives provision of a service may delegate a part of authority for a monitoring service of a projector to another organization such as a subsidiary company or an agent in an affiliated relationship. When a part of the authority related to the monitoring service is delegated to another organization, there is a possibility that the upper limit number specified in the contract is exceeded.

### SUMMARY

A remote monitoring apparatus according to an aspect of the present disclosure is a remote monitoring apparatus that provides a service for browsing a monitoring result of a state of one or more devices to an organization as a subject of a contract for the service and an organization permitted to use the service by the organization, and the remote monitoring apparatus includes a management unit managing contracted number information for associating organization identification information for identifying each of a plurality of organizations including a first organization as a subject of a contract for the service with a contracted number as a number of devices to be monitored, authority information for associating first organization identification information of an organization having a first authority to browse information on a device identified by device identification information and second organization identification information of an organization having a second authority as an authority to register in the service or delete from the service and browse a monitoring result by the service or a third authority as an authority not to register in the service or delete from the service, but to browse the monitoring result by the service with the device identification information for identifying each of the one or more devices, and related organization information for associating third organization identification information for identifying an organization that grants the second authority or the third authority to the organization indicated by the second organization identification information with the second organization identification information, and an output unit outputting confirmation information on a result of a confirmation of the number of devices to be monitored in the contract with the first organization, wherein the output unit executes acquiring a contracted number corresponding to the organization identification information for identifying the first organization using the contracted number information, acquiring second organization identification information associated with the third organization identification information indicating the first organization using the related organization information, acquiring a first monitored number as a number of pieces of the device identification information associated with the organization identification information for identifying the first organization, a second monitored number as a number of pieces of the device identification information associated with the acquired second organization identification information, and a common monitored number as a number of pieces of the device identification information associated with the organization identification information for identifying the first organization and also associated with the acquired second organization identification information, calculating a monitored number of the first organization by subtracting the common monitored number from a sum of the first monitored number and the second monitored number, and, when the monitored number of the first organization exceeds the contracted number, putting a message related to a contract violation in the confirmation information.

### BRIEF DESCRIPTION OF THE DRAWINGS

FIG. 1 is a block diagram showing a configuration example of a remote monitoring system according to an embodiment of the present disclosure.

FIG. 2 is a block diagram showing a configuration example of a remote monitoring server.

FIG. 3 shows an example of an organization that receives a monitoring service.

FIG. 4 shows an example of a data structure of a contract table.

FIG. 5A shows an example of a data structure of an authority table.

FIG. 5B shows another example of the data structure of the authority table.

FIG. 6 shows an example of a data structure of a related organization table.

FIG. 7 shows an example of a data structure of a log table.

FIG. 8 shows an example of a data structure of a browsing permission table.

FIG. 9 is a flowchart showing a flow of processing in a monitoring method executed by an output unit.

FIG. 10 is a flowchart showing a flow of processing in a management method of Modification Example 2.

FIG. 11 is a flowchart showing a flow of processing in a management method of Modification Example 3.

### DESCRIPTION OF EMBODIMENTS

As below, preferred embodiments according to the present disclosure will be described with reference to the accompanying drawings. In the drawings, dimensions and scales of the respective parts are different from real ones as appropriate, and some parts are schematically shown in order to facilitate understanding. Further, the scope of the present disclosure is not limited to these embodiments unless particularly described to limit the present disclosure in the following description.

### 1. Embodiment

### 1-1. Outline of Remote Monitoring System

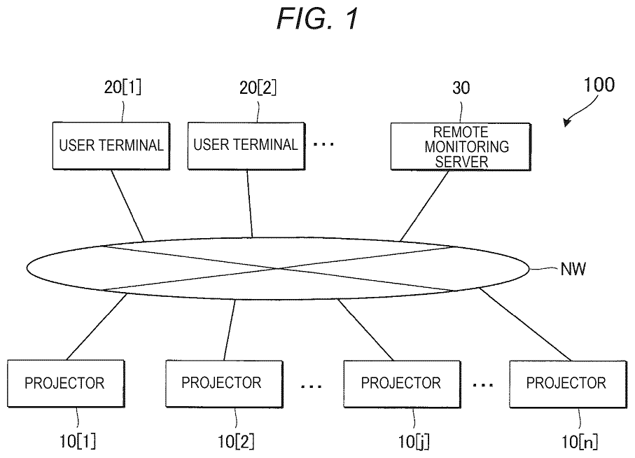

FIG. 1 is a block diagram showing a configuration example of a remote monitoring system 100 according to an embodiment. The remote monitoring system 100 is a system that monitors the states of a plurality of projectors.

The remote monitoring system 100 includes a plurality of projectors 10[1], 10[2], . . . , 10[j], . . . , 10[n], a plurality of user terminals 20[1], 20[2], . . . , and a remote monitoring server 30. Here, “n” is an integer of 2 or more, and “j” is any integer of 1 or more and less than n.

The remote monitoring server 30 communicates with the plurality of projectors 10[1], 10[2], . . . , 10[j], . . . , 10[n] and the plurality of user terminals 20[1], 20[2], . . . via a communication network NW. The remote monitoring server 30 provides a monitoring service for monitoring the states of the projectors. The remote monitoring server 30 is operated by a supplier that provides a monitoring service. The supplier provides a monitoring service to an organization such as a corporation that has concluded a contract. The content of the monitoring service is a matter related to the state of the projector, and may include, for example, dates and times when the power is turned on or off, operation times, and failures. The failure may include specification of a cause of a failure such as a failure of a light source or a failure of a liquid crystal panel. The remote monitoring server 30 collects logs related to the operation of the projector 10 [j] through communication with the projector 10[j]. The remote monitoring server 30 is an example of a remote monitoring apparatus. The projector 10[j] is an example of a device.

The user terminals 20[1], 20[2], . . . are terminals used by persons in charge of an organization that receives the provision of the monitoring service, and may include personal computers, smartphones, and tablet terminals. The user terminals 20[1], 20[2], . . . can receive various notifications such as monitoring reports from the remote monitoring server 30. The user terminals 20[1], 20[2], . . . can confirm the states of the projectors operated in the organization by accessing the remote monitoring server 30.

The projector 10[j] includes an image processing circuit, a light source, a light modulator, and a projection optical system. The image processing circuit is a circuit that controls driving of the light modulation device based on input information. The light source includes, for example, halogen lamps, xenon lamps, ultra-high pressure mercury lamps, LEDs (Light Emitting Diodes), or laser light sources, which respectively emit a red light, a green light, and a blue light. The light modulation device includes three light modulation elements provided to correspond to red, green, and blue. Each of the three light modulation elements is, for example, a display panel such as a transmissive liquid crystal panel, a reflective liquid crystal panel, or a DMD (digital mirror device). The three light modulation elements respectively modulate the red light, the green light, and the blue light based on a signal from the image processing circuit to generate image lights of the respective colors. The image lights of the respective colors are combined by a light combining system into a full-color image light. The projection optical system is an optical system including a projection lens and projects the full-color image light onto a projection target to form an image thereon.

### 1-2. Remote Monitoring Server

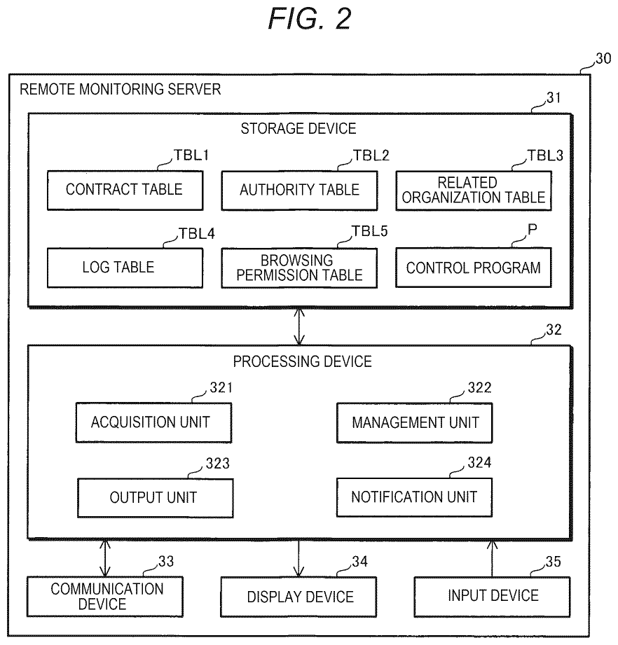

FIG. 2 is a block diagram showing a configuration example of the remote monitoring server 30. The remote monitoring server 30 includes a storage device 31, a processing device 32, a communication device 33, a display device 34, and an input device 35. These devices are communicably coupled to one another.

The storage device 31 is a device that stores programs such as an operating system and application programs to be executed by the processing device 32 and data to be processed by the processing device 32. The storage device 31 includes, for example, a hard disk drive or a semiconductor memory. Part or all of the storage device 31 may be a storage device outside the remote monitoring server 30, or may be provided in an external device such as a server connected to the remote monitoring server 30 via a communication network such as the Internet.

The storage device 31 stores a control program P for execution of the monitoring service, a contract table TBL1, an authority table TBL2, a related organization table TBL3, a log table TBL4, and a browsing permission table TBL5.

The processing device 32 is a processing device having a function of controlling the respective units of the remote monitoring server 30 and a function of processing various data. The processing device 32 includes, for example, a processor such as a CPU (Central Processing Unit). Note that the processing device 32 may be configured with a single processor or multiple processors. Part or all of the functions of the processing device 32 may be implemented by hardware such as a DSP (Digital Signal Processor), an ASIC (Application Specific Integrated Circuit), a PLD (Programmable Logic Device), or an FPGA (Field Programmable Gate Array).

The communication device 33 is a device that can communicate with the projector 10[j], the user terminals 20[1], 20[2], . . . and the like.

The display device 34 displays various images under the control by the processing apparatus 32. The display device 34 is, for example, a display device including various display panels such as a liquid crystal display panel and an organic EL (electro-luminescence) display panel.

The input device 35 is an input device that receives an operation from a user. The input device 35 is not limited to a touch panel, but may be, for example, a touch pad provided separately from the display device 34 or a pointing device such as a mouse.

The processing device 32 reads the control program P stored in the storage device 31. The processing device 32 realizes various functions by executing the read control program P. Specifically, the processing device 32 functions as an acquisition unit 321, a management unit 322, an output unit 323, and a notification unit 324 by executing the control program P.

The acquisition unit 321 acquires a log from the projector 10[j] coupled to the remote monitoring server 30 by controlling the operation of the communication device 33. The acquired log is stored in the log table TBL4 by the management unit 322.

The management unit 322 manages the contract table TBL1, the authority table TBL2, the related organization table TBL3, the log table TBL4, and the browsing permission table TBL5 stored in the storage device 31.

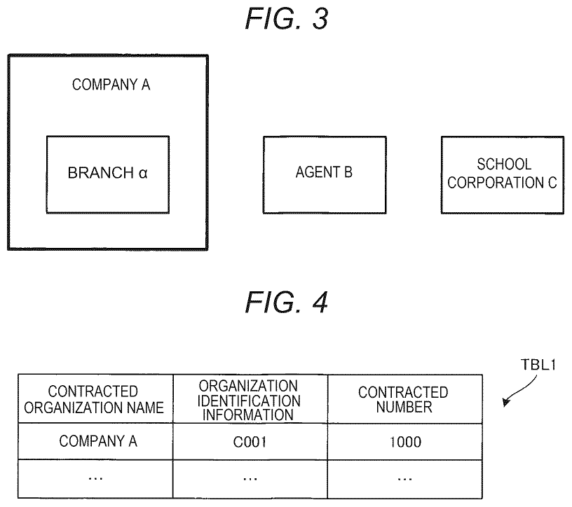

The monitoring service in the embodiment is provided to an organization that has concluded a free contraction with a supplier, an organization that has concluded a paid contraction with the supplier, and an organization designated by the organization that has concluded the paid contraction with the supplier and having concluded the free contraction with the supplier. In the first embodiment, it is assumed that the organizations that receive the monitoring service include organizations shown in FIG. 3. The organizations shown in FIG. 3 are a company A, a branch α as a branch of the company A, an agent B, and a school corporation C. The branch α and the agent B are organizations related to the company A. The school corporation C is a customer of the company A. In the embodiment, any one of the projectors 10[j] is delivered or rented to the school corporation C by the company A. A supplier that provides the monitoring service has concluded a contract without consideration for the monitoring service with the school corporation C. The free contract does not include a contracted number as the number of projectors to be monitored. The free contract is concluded with the supplier, and thereby, free authority related to the monitoring service is granted to the school corporation C. The supplier that provides the monitoring service has concluded a paid contract for the monitoring service with the company A. The paid contract includes the contracted number as the number of projectors to be monitored. The paid contract is concluded with the supplier, and thereby, a paid authority related to the monitoring service is granted to the company A.

The free authority related to the monitoring service includes a first registration authority to register and delete a projector managed by an organization having the right to use the monitoring service and a first monitoring authority to allow the organization having the right to use the monitoring service to browse first information on the projector registered by the organization.

The paid authority related to the monitoring service includes the above described free authority, a second registration authority to register and delete a lower organization managed by the organization having the right to use the monitoring service, a third registration authority for the organization having the right to use the monitoring service to register and delete a projector managed by the lower organization, a second monitoring authority for the organization having the right to use the monitoring service to browse second information on a projector registered by the organization, an authority for the organization having the right to use the monitoring service to browse second information on the projector managed by the lower organization, and a reference authority for the organization having the right to use the monitoring service to refer to second information on a projector managed by an organization designated by the organization having the right to use the monitoring service.

The second information on the projector is information of a type different from the first information on the projector. For example, the first information on the projector is information on an operating state of the projector, and the second information on the projector is information on a technical service of the projector. The second information on the projector may be more detailed information than the first information on the projector. For example, the first information on the projector is a name or an identification code of an abnormality occurring in the projector, and the second information on the projector is a history of a current of the light source, a measurement history of a sensor, or the like when the abnormality occurs in the projector.

In the following description, an authority having a registration authority and a use authority is referred to as a management authority. The management authority is an example of a first authority. The second monitoring authority is an example of a second authority. The reference authority is an example of a third authority.

The company A is a subject of the paid contract for the monitoring service and has a paid authority. The company A registers the branch α and the agent B as lower organizations managed by the company A. Further, the company A sets the second monitoring authority related to the projector managed by each of the branch α and the agent B for the branch α and the agent B, and the company A has the third registration authority to register and delete the projectors managed by the branch α and the agent B and the authority for the company A to browse the second information on the projectors managed by the branch α and the agent B. Accordingly, the branch α and the agent B correspond to organizations that permit the company A as the subject of the paid contract of the monitoring service to browse the second information in the projectors respectively managed by the branch α and the agent B. The company A is an example of a first organization as a subject of a paid contract. The branch α and the agent B are examples of organizations that permit the first organization to browse the second information in the projector managed by each of the branch α and the agent B. Regarding lower organizations and upper organizations, for example, when the own organization is a branch, an upper organization (also referred to as a parent organization) is a company to which the branch belongs and a lower organization is the branch. Or, for example, when the organization is a research and development department, a parent organization is company to which the research and development department belongs, and a lower organization is the research and development department. Or, for example, when the own organization is an organization of a business outsourcing destination, a parent organization is an organization of a business outsourcing source, and a lower organization is the organization of the business outsourcing destination.

Further, the company A sets the second monitoring authority regarding the projector managed by the school corporation C for the school corporation C, and the company A has the reference authority to refer to the second information on the projector managed by the school corporation C. The school corporation C is also an example of an organization that permits the first organization to browse the second information in the projector managed by the school corporation C.

As described above, in the monitoring service, not only the organization as the subject of the paid contract but also the organization permitted by the subject of the paid contract to use the second monitoring authority can browse the second information. In the following description, information for identifying each of the plurality of organizations including the first organization as the subject of the paid contract is referred to as organization identification information.

FIG. 4 shows an example of a data structure of the contract table TBL1. The contract table TBL1 associates a contracted organization name as a subject of a paid contract with a supplier, organization identification information of the organization, and a contracted number as a number of projectors to be monitored. In the example shown in FIG. 4, the contracted organization name [COMPANY A], the organization identification information [C001], and the contracted number [1000] are associated with one another. Therefore, it can be seen that the company A can receive the monitoring service up to 1,000 projectors with reference to the contract table TBL1. The contract table TBL1 is an example of contracted number information. In the embodiment, since the branch α, the agent B, and the school corporation C are not organizations as subjects of the paid contract with the supplier, the contract table TBL1 does not contain information on the branch α, the agent B, and the school corporation C.

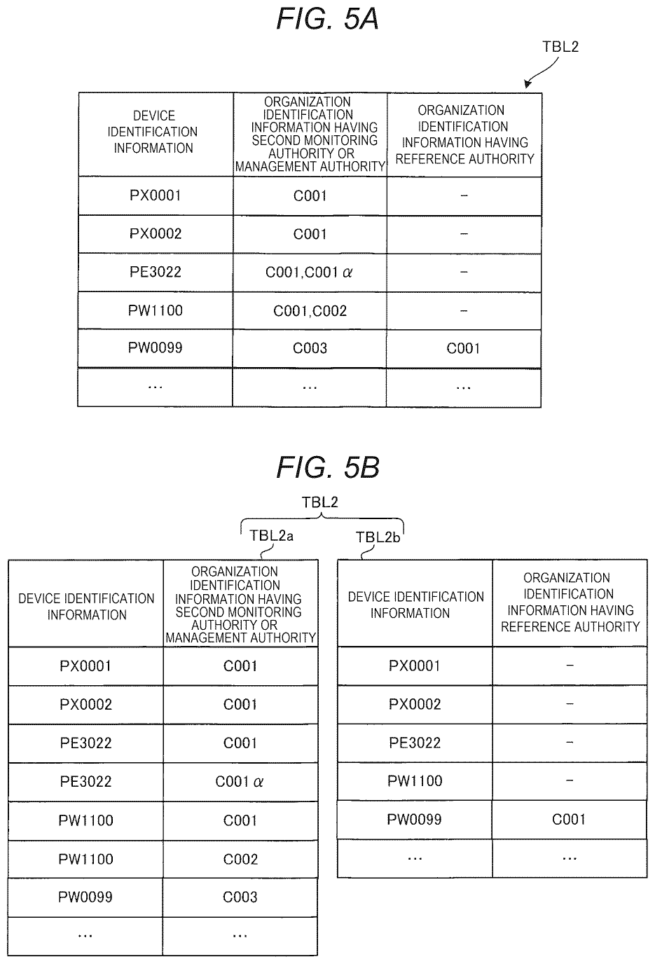

FIG. 5A shows an example of a data structure of the authority table TBL2. The authority table TBL2 associates device identification information, organization identification information of an organization having the second monitoring authority or the management authority, and organization identification information of an organization having the reference authority. The organization identification information of the organization having the management authority is an example of first organization identification information. The organization identification information of the organization having the second monitoring authority or the reference authority is an example of second organization identification information.

The device identification information is information for uniquely identifying one or more projectors 10[1], 10[2], . . . , 10[j], . . . , 10[n] to be monitored by the monitoring service. The device identification information may be, for example, a serial number.

In the example shown in FIG. 5A, the device identification information [PE3022] is associated with the organization identification information [C001] of the organization having the management authority and the organization identification information [C001α] of the organization having the second monitoring authority. [C001] is the organization identification information corresponding to the company A, and [C001α] is the organization identification information corresponding to the branch α. Accordingly, this information means that, regarding the projector corresponding to the device identification information [PE3022], the company A has the management authority and the branch α has the second monitoring authority, and the company A and the branch α can browse the second information on the projector.

The device identification information [PW1100] is associated with the organization identification information [C001] of the organization having the management authority and organization identification information [C002] of an organization having the second monitoring authority. [C002] is the organization identification information corresponding to the agent B. Accordingly, this information means that, regarding the projector corresponding to the device identification information [PW1100], the company A has the management authority and the agent B has the second monitoring authority, and the company A and the agent B can browse the second information on the projector.

The device identification information [PW0099] is associated with organization identification information [C003] of an organization having the second monitoring authority and the organization identification information [C001] of the organization having the reference authority. [C003] is organization identification information corresponding to the school corporation C. Accordingly, this information means that, regarding the projector corresponding to the device identification information [PW0099], the school cooperation C has the second monitoring authority and the school cooperation C can browse the second information on the projector. Further, this information means that, regarding the projector corresponding to the device identification information [PW0099], the company A has the reference authority and the company A cannot delete the projector from the monitoring service, but can refer to the second information on the projector.

FIG. 5B shows another example of the data structure of the authority table TBL2. The authority table TBL2 shown in FIG. 5B contains an authority table TBL2a that associates the device identification information with the organization identification information of the organization having the second monitoring authority or the management authority, and an authority table TBL2b that associates the device identification information with the organization identification information of the organization having the reference authority. Further, each record constituting the authority table TBL2a and the authority table TBL2b associates the device identification information and the organization identification information on a one-on-one basis.

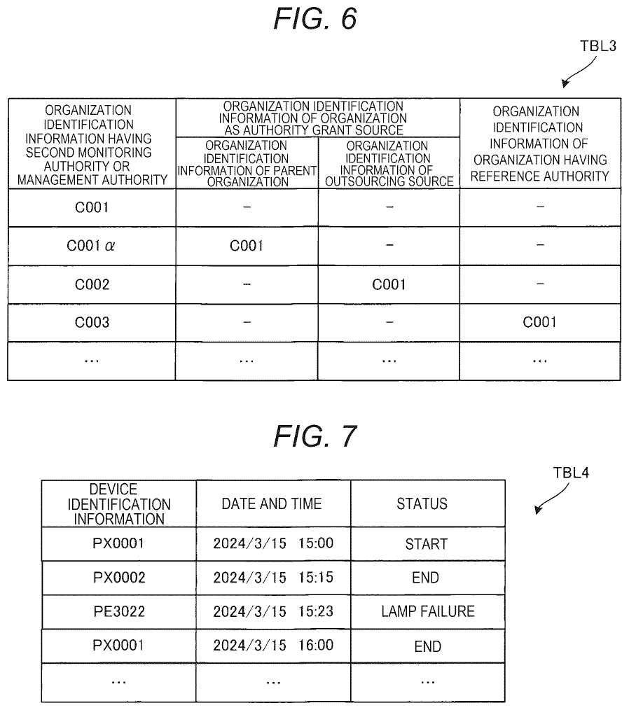

FIG. 6 shows an example of a data structure of the related organization table TBL3. The related organization table TBL3 associates organization identification information of an organization having the second monitoring authority or the management authority, organization identification information of an organization as an authority grant source, and organization identification information of an organization having the reference authority (reference source organization). The organization identification information of the organization having the second monitoring authority or the management authority is an example of second organization identification information. The organization identification information of the organization as the authority grant source or the organization having the reference authority is an example of third organization identification information.

In the example shown in FIG. 6, the organization identification information of the parent organization that grants the second monitoring authority to the organization identification information [C001α] is [C001]. This means that the parent organization of the branch α whose organization identification information is [C001α] is the company A whose organization identification information is [C001]. The organization identification information of the outsourcing source corresponding to the organization identification information [C002] is [C001]. This means that the outsourcing source of the agent B whose organization identification information is [C002] is the company A whose organization identification information is [C001]. The organization identification information of the organization that grants the corresponding reference authority to the organization identification information [C003] is [C001]. This means that the reference source of the school corporation C whose organization identification information is [C003] is the company A whose organization identification information is [C001].

Here, among the plurality of records recorded in the related organization table TBL3, the record without the organization identification information of the parent organization, without the organization identification information of the outsourcing source, and without the reference source indicates the organization as the subject of the paid contract with the supplier. Further, another record in which the organization identification information of the organization having the management authority recorded in the record is recorded as the organization identification information of the parent organization or the organization identification information of the outsourcing source indicates an organization permitted by the organization as the subject of the paid contract to browse the second information. Accordingly, the related organization table TBL3 is an example of the related organization information that associates the organization identification information for identifying the organization as the subject of the paid contract with the organization identification information for identifying the organization permitted by the organization as the subject of the paid contract to browse the second information.

FIG. 7 shows an example of a data structure of the log table TBL4. The log table TBL4 associates the device identification information, date and time, and a status. The status indicates the state of the projector designated by the device identification information. In the example shown in FIG. 7, the power of the projector corresponding to the device identification information [PX0001] is turned on at 15:00, Mar. 15, 2024 and is turned off at 16:00, Mar. 15, 2024. The state of the projector to be monitored can be recognized with reference to the log table TBL4. The date and time and the status are examples of usage information indicating the usage status of the projector. The log table TBL4 is an example of monitoring information.

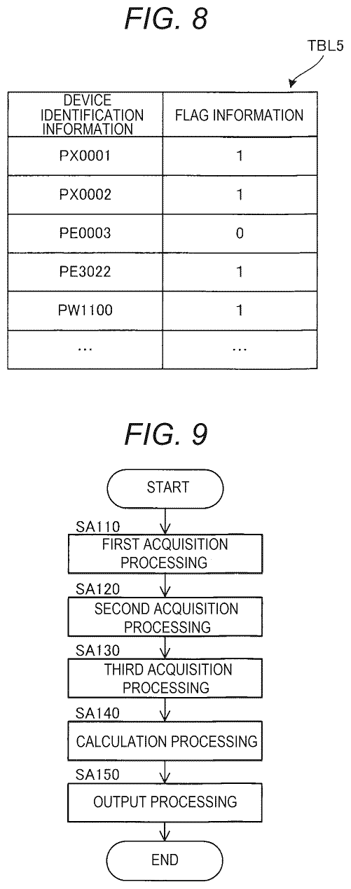

FIG. 8 shows an example of a data structure of the browsing permission table TBL5. The browsing permission table TBL5 associates the device identification information with flag information. The flag information of “1” indicates that browsing of a monitoring result such as a log is permitted, and the flag information of “0” indicates that the browsing of the monitoring result is not permitted. It can be seen whether browsing of the monitoring result of the projector is permitted with reference to the browsing permission table TBL5. The browsing permission table TBL5 is an example of browsing permission information.

The output unit 323 shown in FIG. 2 outputs confirmation information on a result of confirmation of the number of contracted devices to be monitored with respect to each organization by executing a monitoring method that significantly shows the characteristics of the present disclosure. The confirmation information contains a message related to a contract violation when the contract violation in which the number of devices to be monitored exceeds the contracted number occurs. The details of the monitoring method executed by the output unit 323 will be made clear later.

The notification unit 324 shown in FIG. 2 notifies a user terminal 20 used by a system administrator of the organization in which the contract violation that the number of devices to be monitored exceeds the contracted number occurs of the contract violation by transmitting a message related to the contract violation by e-mail or the like via the communication network NW. The system administrator browsing the message using the user terminal 20 can recognize that the contract violation that the number of devices to be monitored exceeds the contracted number has occurred.

FIG. 9 is a flowchart showing a flow of processing in the monitoring method executed by the output unit 323. In the following description, processing of determining the confirmation information on the first organization will be described as an example. The first organization can be optionally selected, but in this example, the company A is assumed. As shown in FIG. 9, the monitoring method includes first acquisition processing SA110, second acquisition processing SA120, third acquisition processing SA130, calculation processing SA140, and output processing SA150. The details of processing of each of the first acquisition processing SA110, the second acquisition processing SA120, the third acquisition processing SA130, the calculation processing SA140, and the output processing SA150 are as follows.

In the first acquisition processing SA110, the output unit 323 acquires a contracted number T corresponding to the organization identification information indicating the first organization by using the contract table TBL1. In the embodiment, the output unit 323 refers to the contract table TBL1 shown in FIG. 4 to acquire “1000”, as the contracted number T corresponding to the organization identification information [C001] whose contracted organization name is the company A.

In the second acquisition processing SA120 subsequent to the first acquisition processing SA110, the output unit 323 acquires the organization identification information (the above described second organization identification information) of the organization for which the second monitoring authority is set by the first organization and the organization identification information (the above described second organization identification information) of the organization for which the first organization has the reference authority by using the related organization table TBL3. Specifically, the output unit 323 acquires the organization identification information associated with the third organization identification information indicating the first organization by using the related organization table TBL3. In this example, the organization identification information of the first organization is [C001]. In the related organization table TBL3 shown in FIG. 6, [C001] is stored as the organization identification information of the parent organization corresponding to the organization identification information [C001α], and [C001] is stored as the organization identification information of the parent organization corresponding to the organization identification information [C002]. Further, in the related organization table TBL3 shown in FIG. 6, the organization identification information of the record in which the organization identification information [C001] of the first organization is stored as the organization identification information of the organization having the reference authority is [C003]. Therefore, in the second acquisition processing SA120 in the embodiment, the output unit 323 acquires [C001α], [C002], and [C003] as the second organization identification information.

In the third acquisition processing SA130 subsequent to the second acquisition processing SA120, the output unit 323 acquires a first monitored number X, a second monitored number Y, and a common monitored number Z by referring to the authority table TBL2. The first monitored number X is the number of pieces of device identification information associated with the organization identification information for identifying the first organization in the authority table TBL2. The second monitored number Y is the number of pieces of device identification information associated with the second organization identification information acquired in the second acquisition processing SA120 in the authority table TBL2. The common monitored number Z is the number of pieces of device identification information associated with the organization identification information for identifying the first organization and associated with the second organization identification information acquired in the second acquisition processing SA120 in the authority table TBL2.

As shown in FIG. 5A, in the authority table TBL2, the device identification information associated with the organization identification information [C001] of the first organization is [PX0001], [PX0002], [PE3022], and [PW1100]. Accordingly, in the embodiment, in the third acquisition processing SA130, the output unit 323 acquires “4” as the first monitored number X. As described above, in the second acquisition processing SA120 in the embodiment, [C001α], [C002], and [C003] are acquired as the second identification information. As shown in FIG. 5A, in the authority table TBL2, the device identification information associated with the organization identification information [C001α] is [PE3022]. In the authority table TBL2, the device identification information associated with the organization identification information [C002] is [PW1100]. In the authority table TBL2, the device identification information associated with the organization identification information [C003] is [PW0099]. Accordingly, in the embodiment, in the third acquisition processing SA130, the output unit 323 acquires “3” as the second monitored number Y. As shown in FIG. 5A, in the authority table TBL2, the organization identification information [C001] and the organization identification information [C001α] are associated with the device identification information [PE3022]. In the authority table TBL2, the organization identification information [C001] and the organization identification information [C002] are associated with the device identification information [PW1100]. Accordingly, in the embodiment, in the third acquisition processing SA130, the output unit 323 acquires “2” as the common monitored number Z.

In the calculation processing SA140 subsequent to the third acquisition processing SA130, the output unit 323 calculates a monitored number W of the first organization by subtracting the common monitored number Z from the sum of the first monitored number X and the second monitored number Y. As described above, in the embodiment, in the third acquisition processing SA130, “4” is acquired as the first monitored number X, “3” is acquired as the second monitored number Y, and “2” is acquired as the common monitored number Z. Therefore, in the calculation processing SA140 of the embodiment, 4+3−2=5 is calculated as the monitored number W of the first organization. The common monitored device number Z is subtracted from the sum of the first monitored device number X and the second monitored device number Y, and thereby, duplicate counting of the monitored number by the organization permitted to use the monitoring service by the first organization can be avoided.

In the output processing SA150 subsequent to the calculation processing SA140, the output unit 323 outputs the confirmation information on a result of confirmation of the number of contracted devices to be monitored with respect to each organization to the display device 34. In the output processing SA150, when the monitored number W of the first organization exceeds the contracted number T, the output unit 323 puts a message related to a contract violation in the confirmation information. This message is, for example, “NUMBER OF MONITORED NUMBER EXCEEDING CONTRACTED NUMBER”. The message is output, and thereby, a management user who uses the remote monitoring server 30 can recognize that the contract violation has occurred.

In the embodiment, since the contracted number T of the company A whose organization identification information is [C001] is 1,000 and the monitored number W calculated in the calculation processing SA140 is 5, no contract violation occurs for the company A and the message is not output. On the other hand, when the contracted number of the company A is 4, the contract violation occurs. It should be noted here that, in the authority table TBL2, the device identification information associated with the organization identification information [C001] of the first organization as the organization identification information of the organization having the second monitoring authority or the management authority is [PX0001], [PX0002], [PE3022], and [PW1100], and the contract violation does not seem to occur from the viewpoint of the number of projectors for which the company A has the second monitoring authority or the management authority. In the embodiment, since the company A has the reference authority for the projector whose device identification information is [PW0099], the number of projectors for which the company A can actually monitor the states is five, and the contract violation occurs. It may be impossible to find the contract violation only by counting the number of second monitoring authorities or management authorities of the company A, however, the contract violation can be found according to the embodiment.

As described above, according to the embodiment, the first organization as the subject of the monitoring service sets the second monitoring authority for another organization, and thereby, even when the other organization is permitted to use the monitoring service, the number of projectors whose states are monitored by the first organization and the organization permitted to use the monitoring service by the first organization can be calculated without excess or deficiency. Since the number of projectors whose states are monitored by the first organization and the organization permitted to use the monitoring service by the first organization can be calculated without excess or deficiency, the management user can accurately and quickly recognize the contract violation that the actual monitored number exceeds the contracted number. Further, according to the embodiment, since the message related to the contract violation is notified to the system administrator of the organization in which the contract violation that the monitored number exceeds the contracted number has occurred, the system administrator can also recognize that the contract violation that the monitored number exceeds the contracted number has occurred.

### 2. Modifications

The above described embodiment may be modified as below.

### 2-1: Modification Example 1

The message related to the contract violation put in the confirmation information by the output unit 323 may be a message indicating an excess number as a difference between the monitored number and the contracted number of the first organization. For example, as a specific example of the message when the excess number is one, a message “MONITORED NUMBER EXCEEDS CONTRACTED NUMBER BY ONE” is given as a message. According to the configuration, the management user can quickly recognize the number of projectors for which the states are actually monitored by the first organization, in other words, the contracted number at the time of contract renewal.

### 2-2: Modification Example 2

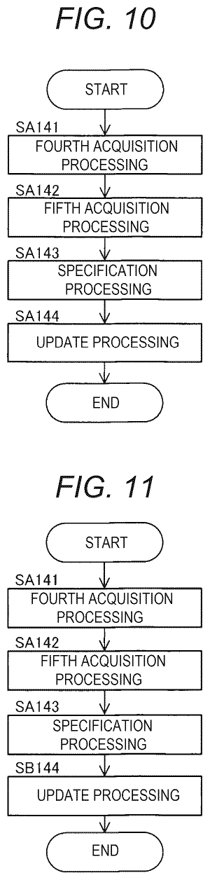

When the output unit 323 confirms that the monitored number W of the first organization exceeds the contracted number T, the management unit 322 may execute the management method of the modification example before the output unit 323 outputs the confirmation information. FIG. 10 is a flowchart showing a flow of processing in the management method. As shown in FIG. 10, the management method includes fourth acquisition processing SA141, fifth acquisition processing SA142, specification processing SA143, and update processing SA144.

In the fourth acquisition processing SA141, the management unit 322 acquires the device identification information associated with at least one of the organization identification information for identifying the first organization and the second organization identification information acquired in the second acquisition processing SA120 as the organization identification information of the organization having the management authority or the second monitoring authority in the authority table TBL2. In the fifth acquisition processing SA142 subsequent to the fourth acquisition processing SA141, the management unit 322 acquires the usage information corresponding to the device identification information acquired in the fourth acquisition processing SA141 by using the log table TBL4.

In the specification processing SA143 subsequent to the fifth acquisition processing SA142, the management unit 322 generates list information in which a number of pieces of device identification information corresponding to the difference between the contracted number T and the monitored number W are arranged in ascending order of the use frequency based on the usage information acquired in the fifth acquisition processing SA142, thereby specifying a projector having a lower use frequency. More specifically, the management unit 322 generates the list information by reading a number of pieces of device identification information corresponding to the difference between the contracted number T and the monitored number W in chronological order of the last operation date and time (date and time when the power supply is most recently turned off) from the log table TBL4. For example, assuming that the contracted number T of the company A is four and the monitored number W of the company A is five, the management unit 322 generates list information including one piece of device identification information. As shown in FIG. 7, since the device identification information of the projector having the oldest date and time when the power was turned off most recently is [PX0002], the management unit 322 generates list information including only one piece of device identification information [PX0002].

In the update processing SA144 subsequent to the specification processing SA143, the management unit 322 deletes the record including the device identification information contained in the list information generated in the specification processing SA143 among the records including the organization identification information of the first organization or the second organization identification information acquired in the second acquisition processing SA120 as the organization identification information of the organization having the management authority or the second monitoring authority in the authority table TBL2. As a result, the contract violation is resolved. For example, when the device identification information contained in the list information is [PX0002], a record including any of [C001], [C001α], [C002], and [C003] as the organization identification information of the organization having the management authority or the second monitoring authority and having the device identification information of [PX0002] is deleted from the authority table TBL2. When the management method of the modification example is executed, the output unit 323 may put a message indicating that the device having the lower use frequency is deleted from the monitoring target in the confirmation information as a message related to the contract violation, and the notification unit 324 may notify the system administrator of the organization in which the contract violation has occurred of the message. According to the configuration, since the excess of the number of monitored devices with respect to the contracted number is resolved by deletion of the device having the lower use frequency from the monitoring target, the first organization can continue to use the monitoring service without a contract renewal.

### 2-3: Modification Example 3

When the output unit 323 confirms that the monitored number W of the first organization exceeds the contracted number T, the management unit 322 may execute the management method of the modification example before the output unit 323 outputs the confirmation information. FIG. 11 is a flowchart showing a flow of processing in the management method. In FIG. 11, the same processing steps as those in FIG. 10 have the same signs. As is clear from comparison between FIG. 11 and FIG. 10, the management method according to the modification example is different from the management method according to Modification Example 2 in that update processing SB144 is provided instead of the update processing SA144. In the update processing SB144, the management unit 322 updates the flag information stored in the browsing permission table TBL5 in association with the device identification information contained in the list information generated in the specification processing SA143 from browsing permitted to browsing unpermitted, thereby maintaining the monitored number equal to or less than the contracted number. When the management method of the modification example is executed, the output unit 323 may put a message indicating that a monitoring result of a device having a lower use frequency is updated to be browsing unpermitted in the confirmation information as the message related to the contract violation, and the notification unit 324 may notify the system administrator of the organization in which the contract violation has occurred of the message. According to the configuration, like Modification Example 2, the status in which the monitored number W exceeds the contracted number T can be resolved, and the monitoring service can be continuously used without a contract renewal. Further, as compared with Modification Example 2, when the contract is renewed by increase of the contracted number, it is not necessary to re-register the projector to be monitored, and the work load on the user using the system can be reduced.

### 2-4: Modification Example 4

The device to be monitored in the above described embodiments is the projector. However, the device to be monitored in the present disclosure is not limited to the projector, but may be a printer, a scanner, an electronic blackboard, or a digital signage. The control program P may be manufactured alone, or may be provided for value or free of charge. Specific forms for providing the control program P include a form for writing and providing the program P in a computer-readable recording medium such as a flash ROM and a form for downloading and providing the program P through an electrical communication line such as the Internet.

### 3. APPENDIXES

The present disclosure is not limited to the above described embodiments and modification examples and can be implemented in various configuration without departing from the spirit and scope of the present disclosure. For example, the present disclosure can also be implemented in the following configurations. Technical features in the above described embodiments corresponding to technical features in the configurations described below can be replaced or combined as appropriate in order to solve a part or all of the problems of the present disclosure or in order to achieve a part or all of the effects of the present disclosure. Further, the technical features can be deleted as appropriate unless described as essential features in the present specification.

As below, the summary of the present disclosure will be appended.

### Appendix 1

A configuration of a remote monitoring apparatus according to the present disclosure is a remote monitoring apparatus that provides a service for browsing a monitoring result of a state of one or more devices to an organization as a subject of a contract for the service and an organization permitted to use the service by the organization, and the remote monitoring apparatus includes a management unit managing contracted number information for associating organization identification information for identifying each of a plurality of organizations including a first organization as a subject of a contract for the service with a contracted number as a number of devices to be monitored, authority information for associating first organization identification information of an organization having a first authority to browse information on a device identified by device identification information and second organization identification information of an organization having a second authority as an authority to register in the service or delete from the service and browse a monitoring result by the service or a third authority as an authority not to register in the service or delete from the service, but to browse the monitoring result by the service with the device identification information for identifying each of the one or more devices, and related organization information for associating third organization identification information for identifying an organization that grants the second authority or the third authority to the organization indicated by the second organization identification information with the second organization identification information, and an output unit outputting confirmation information on a result of a confirmation of the number of devices to be monitored in the contract with the first organization, wherein the output unit executes acquiring a contracted number corresponding to the organization identification information for identifying the first organization using the contracted number information, acquiring second organization identification information associated with the third organization identification information indicating the first organization using the related organization information, acquiring a first monitored number as a number of pieces of the device identification information associated with the organization identification information for identifying the first organization, a second monitored number as a number of pieces of the device identification information associated with the acquired second organization identification information, and a common monitored number as a number of pieces of the device identification information associated with the organization identification information for identifying the first organization and also associated with the acquired second organization identification information, calculating a monitored number of the first organization by subtracting the common monitored number from a sum of the first monitored number and the second monitored number, and, when the monitored number of the first organization exceeds the contracted number, putting a message related to a contract violation in the confirmation information. According to the configuration of (Appendix 1), the number of projectors whose states are monitored by the first organization and the organization permitted to use the monitoring service by the first organization can be calculated without excess or deficiency.

### Appendix 2

A remote monitoring apparatus having a more preferred configuration is the remote monitoring apparatus according to (Appendix 1), wherein, when the monitored number of the first organization exceeds the contracted number, the message indicates that the monitored number of the first organization exceeds the contracted number. According to the configuration of (Appendix 2), the user can recognize the occurrence of the contract violation through the message.

### Appendix 3

A remote monitoring apparatus having another preferred configuration is the remote monitoring apparatus according to (Appendix 1), wherein the management unit further manages monitoring information for associating usage information indicating a usage status of each of the one or more devices with the device identification information, when the output unit confirms that the monitored number of the first organization exceeds the contracted number, acquires the device identification information associated with at least one piece of the organization identification information for identifying the first organization and the acquired second organization identification information in the authority information, acquires usage information corresponding to the acquired device identification information using the monitoring information, specifies device identification information in ascending order of a use frequency based on the acquired usage information, and deletes an association of the device identification information in ascending order of the use frequency from associations of the organization identification information of the first organization or the acquired second organization identification information with the device identification information in the authority information, thereby resolving the contract violation, and the output unit puts a message indicating a device having a lower use frequency is deleted from the devices to be monitored as the message related to the contract violation in the confirmation information. According to the configuration of (Appendix 3), the first organization can continue to use the service without a contract renewal.

### Appendix 4

A remote monitoring apparatus having another preferred configuration is the remote monitoring apparatus according to (Appendix 1), wherein the management unit further manages browsing permission information for associating the device identification information with flag information indicating whether browsing of the monitoring result is permitted, manages monitoring information for associating usage information indicating a usage status of each of the one or more devices with the device identification information, when the output unit confirms that the monitored number of the first organization exceeds the contracted number, acquires the device identification information associated with the organization identification information for identifying the first organization or the acquired second organization identification information in the authority information, acquires usage information corresponding to the acquired device identification information using the monitoring information, specifies device identification information in ascending order of a use frequency based on the acquired usage information, and updates the flag information associated with the device identification information specified in ascending order of the use frequency from browsing permitted to browsing unpermitted in the browsing permission information, thereby resolving the contract violation, and the output unit puts a message indicating that browsing of a monitoring result of a device having a lower use frequency is updated to be unpermitted as the message related to the contract violation in the confirmation information. According to the configuration of (Appendix 4), as compared with the configuration of (Appendix 3), it is not necessary to re-register the device later, and the work load on the user using the remote monitoring apparatus can be reduced.

### Appendix 5

A remote monitoring apparatus having yet another preferred configuration is the remote monitoring apparatus according to (Appendix 3) or (Appendix 4), wherein the usage information indicates at least a last operation date and time for each of the one or more devices, and to specify the device identification information in ascending order of the use frequency based on the acquired usage information is to specify the device identification information in chronological order of the last operation date and time. According to the configuration of (Appendix 5), the device identification information having a lower use frequency can be specified in chronological order of the last operation date and time.

### Appendix 6

A remote monitoring apparatus having another preferred configuration is the remote monitoring apparatus according to (Appendix 1), wherein the output unit puts a message indicating an excess number as a difference between the monitored number of the first organization and the contracted number as the message related to the contract violation in the confirmation information. According to the configuration of (Appendix 6), the user of the remote monitoring apparatus can quickly recognize the excess number.

What is claimed is:

1. A remote monitoring apparatus that provides a service for browsing a monitoring result of a state of one or more devices to an organization as a subject of a contract for the service and an organization permitted to use the service by the organization, the remote monitoring apparatus executes:
managing contracted number information, authority information, and related organization information with the second organization identification information; and
outputting confirmation information on a result of a confirmation of the number of devices to be monitored in the contract with the first organization,
wherein the contracted number information is information for associating organization identification information for identifying each of a plurality of organizations including a first organization as a subject of a contract for the service with a contracted number as a number of devices to be monitored,
wherein the authority information is information for associating first organization identification information of an organization having a first authority to browse information on a device identified by device identification information and second organization identification information of an organization having a second authority as an authority to register in the service or delete from the service and browse a monitoring result by the service or a third authority as an authority not to register in the service or delete from the service, but to browse the monitoring result by the service with the device identification information for identifying each of the one or more devices,
wherein the related organization information for associating third organization identification information for identifying an organization that grants the second authority or the third authority to the organization indicated by the second organization identification information, and
wherein the remote monitoring apparatus executes
acquiring a contracted number corresponding to the organization identification information for identifying the first organization using the contracted number information,
acquiring second organization identification information associated with the third organization identification information indicating the first organization using the related organization information,
acquiring a first monitored number as a number of pieces of the device identification information associated with the organization identification information for identifying the first organization, a second monitored number as a number of pieces of the device identification information associated with the acquired second organization identification information, and a common monitored number as a number of pieces of the device identification information associated with the organization identification information for identifying the first organization and also associated with the acquired second organization identification information,
calculating a monitored number of the first organization by subtracting the common monitored number from a sum of the first monitored number and the second monitored number, and
putting a message related to a contract violation in the confirmation information, when the monitored number of the first organization exceeds the contracted number.

2. The remote monitoring apparatus according to claim 1, wherein
when the monitored number of the first organization exceeds the contracted number, the message indicates that the monitored number of the first organization exceeds the contracted number.

3. The remote monitoring apparatus according to claim 1, wherein
the remote monitoring apparatus further manages monitoring information for associating usage information indicating a usage status of each of the one or more devices with the device identification information, when confirming that the monitored number of the first organization exceeds the contracted number, acquires the device identification information associated with at least one piece of the organization identification information for identifying the first organization and the acquired second organization identification information in the authority information, acquires usage information corresponding to the acquired device identification information using the monitoring information, specifies device identification information in ascending order of a use frequency based on the acquired usage information, and deletes an association of the device identification information in ascending order of the use frequency from associations of the organization identification information of the first organization or the acquired third organization identification information with the device identification information in the authority information, thereby resolving the contract violation, and
wherein the confirmation information includes a message indicating a device having a lower use frequency is deleted from the devices to be monitored as the message related to the contract violation.

4. The remote monitoring apparatus according to claim 1, wherein
the remote monitoring apparatus further manages browsing permission information for associating the device identification information with flag information indicating whether browsing of the monitoring result is permitted, manages monitoring information for associating usage information indicating a usage status of each of the one or more devices with the device identification information, when confirming that the monitored number of the first organization exceeds the contracted number, acquires the device identification information associated with the organization identification information for identifying the first organization or the acquired second organization identification information in the authority information, acquires usage information corresponding to the acquired device identification information using the monitoring information, specifies device identification information in ascending order of a use frequency based on the acquired usage information, and updates the flag information associated with the device identification information specified in ascending order of the use frequency from browsing permitted to browsing unpermitted in the browsing permission information, thereby resolving the contract violation, and
wherein the confirmation information includes a message indicating that browsing of a monitoring result of a device having a lower use frequency is updated to be unpermitted as the message related to the contract violation.

5. The remote monitoring apparatus according to claim 3, wherein
the usage information indicates at least a last operation date and time for each of the one or more devices, and
to specify the device identification information in ascending order of the use frequency based on the acquired usage information is to specify the device identification information in chronological order of the last operation date and time.

6. The remote monitoring apparatus according to claim 1, wherein
the confirmation information includes a message indicating an excess number as a difference between the monitored number of the first organization and the contracted number as the message related to the contract violation in the confirmation information.
